(19) United States
(12) Patent Application Publication
(10) Pub. No.: US 2009/0151503 A1
(43) Pub. Date: Jun. 18, 2009

(54) Attachable Lever Arm for Round Doorknobs

(76) Inventor: Leo D. Stafford, JR., Reno, NV (US)

Correspondence Address: DONALD W. MEEKER, 924 EAST OCEAN FRONT, # E, NEWPORT BEACH, CA, 92661, US

(21) Appl. No.: 11/955,387

(22) Filed: Dec. 13, 2007

(51) Int. Cl. E05B 7/00; E05B 1/00

(52) U.S. Cl. 74/525; 16/412

(57) ABSTRACT

The lever arm is a tube containing a threaded adjustment assembly to receive the ends of an elasticized material to form an adjustable loop on one end to fit over and tighten around a round doorknob. The doorknob is opened by engaging the tube as a lever arm.

### CROSS-REFERENCE TO RELATED APPLICATIONS

Not Applicable.

### STATEMENT REGARDING FEDERALLY SPONSORED RESEARCH OR DEVELOPMENT

Not Applicable.

### THE NAMES OF THE PARTIES TO A JOINT RESEARCH OR DEVELOPMENT

Not Applicable.

### BACKGROUND OF THE INVENTION

1. Field of the Invention

The present invention relates to lever attachments for existing doorknobs and particularly to a doorknob lever arm for allowing a person having poor grip to turn the doorknob which comprises a strip of rubber, similar to a bicycle inner tube, which is formed into a loop with the both ends secured inside a tube, such as a PVC pipe with an end cap; the rubber loop is stretched over a door knob and is tightened using a toggle screw within the tube, then the tube is used as a lever to turn the door knob with ease.

2. Description of Related Art Including Information Disclosed Under 37 CFR 1.97 and 1.98

Doorknobs can be difficult to operate for the young, elderly and those suffering such physical handicaps as severe arthritis or partial paralysis affecting the use of the hand. In some cases the disability is so severe that the door knob may not even be turned two-handedly. For this reason doors in many households and in most commercial or industrial buildings now use an operating lever, in place of the standard doorknob. The prior art devices attempting to solve the problem of turning round doorknobs fail to provide an inexpensive simple and easy-to-use device.

U.S. Pat. No. 4,783,883, issued Nov. 15, 1988 to Szalay, indicates lever assists for door knobs. The levers provide for increased leverage to effect a more easy turning of a door knob to which they are attached.

Two U.S. Pat. No. 2,756,088 issued Jul. 24, 1956 and U.S. Pat. No. 2,801,122 issued Jul. 30, 1957 to Sutter, show doorknob extension handles which comprise a lever with an undercurved cavity which embraces the doorknob. A flexible band is attached to a first end of the lever, encircles the perimeter of the knob and is fastened to a mid-portion of the handle and is tightened using a screw fastener. A second end of the lever is then moved to turn the doorknob with ease.

U.S. Pat. No. 2,808,282, issued Oct. 1, 1957 to Peoples, indicates a lever attachment for door knobs which comprises a pliant door knob cover which stretches over the door knob and an operating lever attached to an external portion of the door knob cover.

U.S. Pat. No. 6,447,031, issued Sep. 10, 2002 to O'Hanlon, concerns a lever handle for attachment to a round door lock handle which comprises a metal strip which has an arced width which clamps on to two peripheries of the door knob and which arced surface is also curved to encircle and contact 90% of the door knob diameter and which curved section has two free ends which are pulled into a tubular section by means of a hook bolt and end nut, the whole being assembled on to the door knob without the use of any tools or other attaching means and which complete device can be readily attached and removed for further installation on other door knobs as required.

U.S. Pat. No. 3,575,453, issued Apr. 20, 1971 to Hohl, is for an easy door opener with a door knob grip section and a lever handle section. The door knob grip section is a resilient curved elongated thin element with inner and outer ends, almost closed on itself and having an inverted U-shaped cross section, serrated with teeth on opposed parallel edges. The inner end terminates in an outwardly extending lever handle which is joined to the inner end at a junction, and extending over this junction to the outer end of the grip section is a threaded member whereby the curved grip section can be placed around a door knob and the threaded member fastened so that the resilient grip section closes in on the handle. The serrated teeth grip the contours of the door knob and the user can readily open the door with the lever handle.

U.S. Pat. No. 4,504,087, issued Mar. 12, 1985 to Pennington, shows a lever attachment for a rotary door knob which comprises an arcuate collar adapted to embrace the knob, the collar terminating at its opposite ends in arms and being formed on an arc such that the arms have a tendency to diverge. The collar is formed of material sufficiently resilient to enable the arms to be moved into engagement with one another, thereby causing radial contraction of the collar and enabling the latter to grip the knob. The arms are releasably maintained in engagement by any one of a number of different kinds of latches.

U.S. Pat. No. 4,285,536, issued Aug. 25, 1981 to McCoy, puts forth a universal lever handle attachment for a door knob wherein a knob engaging and gripping portion is adapted to fit over a door knob, an intermediate portion is connected to the knob engaging portion and is configured to operatively receive a universal screw adjusting assembly which tightens the knob engaging portion onto the door knob and a handle portion extending outwardly from the intermediate portion. The universal screw means is operatively arranged to cooperate with the intermediate portion to provide for right or left hand installation.

U.S. Pat. No. 4,971,375, issued Nov. 20, 1990 to Grecco, describes a retrofit lever handle used by a disabled person for turning a door knob on a door. The retrofit lever consists of an inner member that fits into an outer member, which has a curved arm and tab thereon. The inner member is adjustable to grip the door knob on the door so that any portion of the disabled person can make contact with the curved arm while the tab will prevent slippage off of the arm. Movement of the arm will turn the door knob thus enabling the disabled person to open and close the door.

U.S. Pat. No. 5,664,287, issued Sep. 9, 1997 to Sendelbach, provides a handle attachment for round door knobs to make the door knob easy to turn by pushing a levering handle. The handle and clamp are in two pieces that are fastened together to form a single door knob clamp and handle. The two pieces are adjustable relative to each other so the clamp can be opened and closed allowing attachment to a variety of different sized and different shaped door knobs. Easy to install and easy to remove, the invention is designed to remain on the door knob once it has been installed, but it can be removed if desired or necessary. A child cord is affixed through an aperture in the free end of the handle making it easy for a child to open a door.

What is needed is an inexpensive easy-to-use device for instantly converting a round doorknob into a lever handle door opener and instantly converting back to the round doorknob as desired.

### BRIEF SUMMARY OF THE INVENTION

An object of the present invention is to provide a lever arm with an adjustable elasticized loop extending out one end of the lever arm so that the loop is removably attached and tightened around a round doorknob so that the lever arm turns the doorknob thereby providing an easy-to-use device for instantly converting a round doorknob into a lever handle door opener and instantly converting back to the round doorknob as desired.

Another object of the present invention is to provide a simple tube with an internal threaded fastener for receiving the ends of an elasticized loop to tighten and loosen the loop around a doorknob as an inexpensive means for attaching a lever arm to a round doorknob.

In brief, the present invention comprises a tubular lever arm handle having a protruding elasticized loop extending out a distal end of the lever arm so that the present invention converts a regular door knob into a latch or lever type door handle by attaching the elasticized end loop around a doorknob and tightening the loop around the doorknob with a loop adjusting knob on the proximal end of the lever arm and using the lever arm to turn the doorknob. It attaches to any existing door knob. The purpose of the present invention is to make it easier for people suffering with disabilities such as authorities to open doors.

An advantage of the present invention is that it provides a low cost product that will make life a little easier for people with any sort of disability that makes operating a regular round type door knob difficult.

Another advantage of the present invention is that it is a portable device which may be moved to other doorknobs as desired.

### BRIEF DESCRIPTION OF THE SEVERAL VIEWS OF THE DRAWINGS

These and other details of my invention will be described in connection with the accompanying drawings, which are furnished only by way of illustration and not in limitation of the invention, and in which drawings:

FIG. 1 is a perspective view in partial section showing the attachable lever arm of the present invention with the lever arm in section showing the adjustable mechanism for tightening and loosening the doorknob grasping loop with the loop aligned for encircling a round doorknob;

FIG. 2 is a perspective view of the attachable lever arm of FIG. 1 with the loop encircling a round doorknob and the lever arm extending horizontally being gripped by a user to turn a round doorknob with the lever arm.

### DETAILED DESCRIPTION OF THE INVENTION

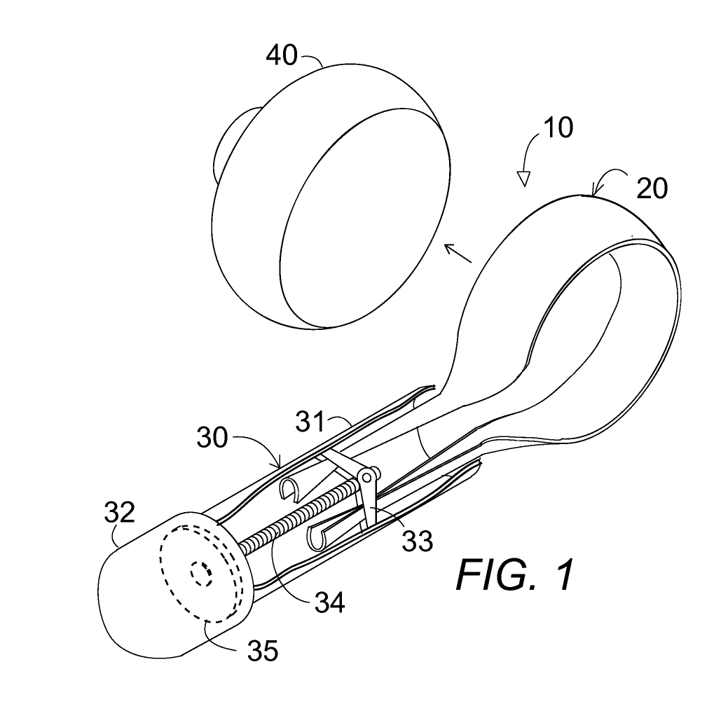

In FIGS. 1-3, an attachable and removable door knob lever arm device 10 comprises a lever arm 30 with an adjustable elasticized loop 20 for attaching to a round door knob 40 to facilitate turning the round door knob with the lever arm action of the device.

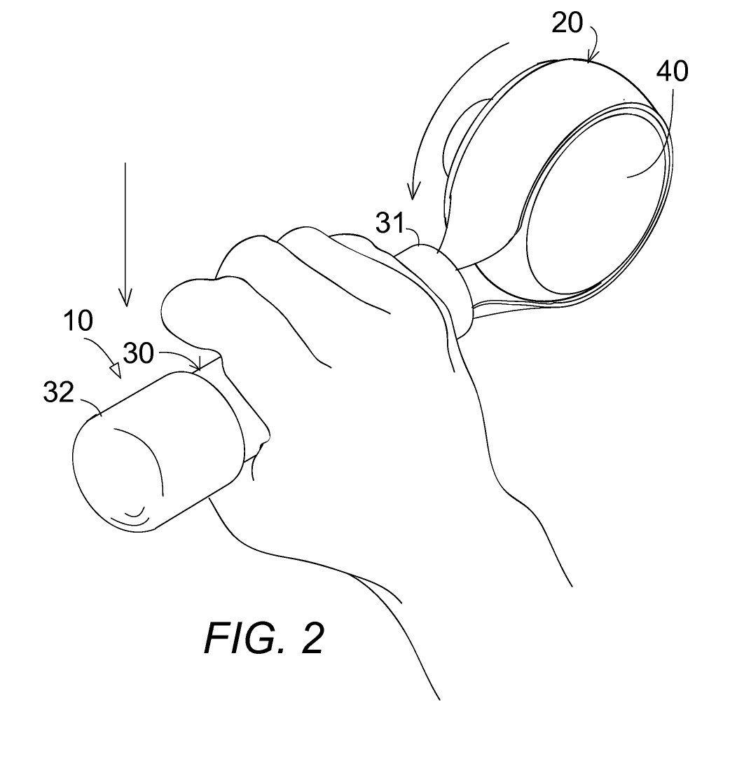

In FIG. 1, the lever arm 30 comprises a rigid elongated tube 31 having a hollow interior along its length which may be a length of PVC pipe having an adjusting knob 32 at one end and interior means for adjusting the tension of the end loop 20.ln FIG. 1, the doorknob grasping elasticized loop 20 comprises an elongated strip of elasticized material, which may be similar to a bicycle inner tube. The loop 20 is formed by the two ends being attached within the hollow interior of the lever arm 30. The loop 20 extends out of the lever arm for encircling and gripping a doorknob 40 within the elasticized loop, as shown in FIG. 2.

In FIG. 1, a threaded adjustment mechanism 33, 34, 35 is movably attached within the hollow interior of the lever arm tube 31. The adjustment mechanism comprises a means for gripping and retaining the two ends of the elasticized loop 20 so that reversibly adjusting the threaded shaft 34 of the adjustment mechanism causes tightening of the loop 20 around a doorknob 40 as shown in FIG. 2. This allows turning the doorknob using the lever arm for a mechanical advantage. Alternately loosening of the threaded shaft 34 adjustment mechanism causes loosening of the elasticized loop 20 to remove the elasticized loop from the door knob 40.

The threaded adjustment mechanism comprises a threaded shaft 34 installed at one end through a washer at one end of the tube 31. The threaded shaft 34 is rotatably attached to an internally threaded shaft receiving element 33 slidably mounted within the hollow interior of the lever arm tube 31. The two ends of the elasticized loop 20 are attached to the shaft receiving element 33 with the loop extending out of the distal end of the lever arm 30, so that turning the threaded shaft 34 alternately tightens or loosens the elasticized loop 20 around the doorknob 40.

The shaft receiving element 33 preferably comprises a threaded shaft toggle bolt 34 having two spring loaded toggle wing arms and the means for gripping and retaining the two ends of the elasticized loop 20. This may be accomplished with slots in the spring loaded arms for engaging the two ends of the elasticized loop. An end cap 32 covers the toggle bolt.

Preferably, the lever arm tube 31 comprises a piece of ¾″ PVC pipe 3-¾″ to 4″ long, and the adjusting mechanism comprises a ⅛″×3″ toggle bolt assembly 34 and 33, a ⅛″×1″ flat washer 35 where the threaded bolt shaft 34 connects to the ¾″ PVC end cap acting as the adjustment knob 32, and a 9″ long section of 2.325″ bike inter tube used as an elasticized loop 20. A 3-¾″ to 4″×4-½″ long strip of heavy duty shelf covering may be used as an optional covering over the tube as a decorative cover. Metallic paints and self adhesive shelf covering can be used to make the assembly a bit more attractive, but this is not necessary if it adds too much to the cost of the product.

To assemble the attachable lever arm 10, the following steps may be used:
1. The flat washer 35 is slipped on to the ⅛″ bolt;
2. The toggle 33 is installed on to the bolt 34;
3. A ¼″ hole is punched ¾″ from each end of the strip of inner tube;
4. The strip of inter tube is folded in half;
5. One side of the tube slides on to each wing of the toggle;
6. Starting with the tube slide the whole assembly slides through the PVC pipe until the flat washer rests firmly against the end of the PVC tube.

In use, the exposed “U” shape tube loop 20 slides over any door knob 40.The lever arm is positioned in the desired location, usually horizontally.

A screwdriver may be used to tighten the toggle bolt until the tube is snug. The end cap is snapped over the end of the PVC tube to cover up the head of the toggle bolt and the flat washer. Then the round doorknob 40 may be turned easily by leaning down on the attached lever arm 10.

It is understood that the preceding description is given merely by way of illustration and not in limitation of the invention and that various modifications may be made thereto without departing from the spirit of the invention as claimed.

What is claimed is:

1. An attachable door knob lever arm device for attaching to a round door knob to facilitate turning the round door knob, the device comprising:
a lever arm comprising a rigid elongated tube having a hollow interior along its length;
a doorknob grasping elasticized loop comprising an elongated strip of elasticized material formed into a loop comprising two ends attached within the hollow interior of the lever arm and a loop extending out of the lever arm for encircling and gripping a round doorknob within the elasticized loop;
a threaded adjustment mechanism movably attached within the hollow interior of the lever arm, the adjustment mechanism comprising a means for gripping and retaining the two ends of the elasticized loop so that reversibly adjusting the adjustment mechanism causes tightening of the loop around a round doorknob for turning the round doorknob using the lever arm for a mechanical advantage in turning and alternately loosening of the adjustment mechanism causes loosening of the elasticized loop to remove the elasticized loop from the round door knob to provide an attachable and removable door knob lever arm for turning round doorknobs.

2. The device of claim 1 wherein the threaded adjustment mechanism comprises a threaded shaft installed through a washer at one end to a proximal end of the lever arm and the threaded shaft rotatably attached to an internally threaded shaft receiving element slidably mounted within the hollow interior of the lever arm, the two ends of the elasticized loop attached to the shaft receiving element with the loop extending out of a distal end of the lever arm, so that turning the threaded shaft alternately tightens or loosens the elasticized loop around the doorknob.

3. The device of claim 2 wherein the threaded adjustment element comprises a toggle bolt having two spring loaded toggle arms and the means for gripping and retaining the two ends of the elasticized loop comprises slots in the spring loaded toggle arms for engaging the two ends of the elasticized loop.
